(19) United States
(12) Patent Application Publication
(10) Pub. No.: US 2003/0006775 A1
(43) Pub. Date: Jan. 9, 2003

(54) System for measuring spark plug suppressor resistance under simulated operating conditions

(76) Inventor: James Tordt Wright, Anderson, IN (US)

Correspondence Address: MARGARET A. DOBROWITSKY, DELPHI TECHNOLOGIES, INC., Mail Code: 480-414-420, P.O. Box 5052, Troy, MI, 48007-5052, US

(21) Appl. No.: 09/900,553

(22) Filed: Jul. 6, 2001

(51) Int. Cl. F02P 17/00

(52) U.S. Cl. 324/399

(57) ABSTRACT

An improved system for measuring spark plug suppressor resistance under simulating operating conditions includes a controller, a high voltage power supply, a mounting fixture, and a non-contact IR temperature detector. The controller commands the high voltage power supply to source a preselected level of current through the spark plug having a magnitude consistent with actual spark currents. The current sourcing establishes a self-heating arrangement, and the heightened spark plug temperatures and associated resistance simulate actual engine operating conditions. The controller outputs a display of measured resistance values as a function of time, and overlays a trace of the corresponding temperature values.

### BACKGROUND OF THE INVENTION

1. Technical Field

The present invention relates generally to ignition systems and components thereof, and more particularly to a system for measuring spark plug suppressor resistance under simulated operating conditions.

2. Description of the Related Art

Spark plugs are known generally for use in ignition of an air-fuel mixture in an internal combustion engine. It is further known to produce a spark plug having a so-called suppressor resistor, which is composed typically of glass and carbon or metal oxides, contained in an electrode bore surrounded by a ceramic insulator or the like. The suppressor resistor is known to reduce noise as well as electromagnetic interference when sparking occurs. The composition used for the suppressor resistance also functions to seal the plug so that compression condition in the combustion chamber can be maintained.

One consequence of having the suppressor resistor is that it absorbs energy. Conventional separate-mount style ignition coils have in the past delivered sufficient energy to the spark plug so that the energy loss attributable to the suppressor resistor was generally not critical (i.e., there remained sufficient energy delivered to the spark plug gap to initiate combustion). However, there has been an increasing popularity of so-called “pencil” coils (i.e., of the type that are above and directly mounted to the spark plug). Such pencil coils do not generally allow for much extra energy to be delivered to the plug, because of, for example, space constraints which limit core material and windings. Moreover, even separate mount ignition coils are being designed with increasingly less headroom because of the desire to reduce core/winding materials in order to reduce cost.

The foregoing factors elevate the importance in understanding how much energy the suppressor resistor portion of the plug absorbs, and thus how much energy is left to be delivered to the spark gap. However, each spark plug manufacturer selects its own combination of materials and processes for producing the suppressor resistor, making an accurate characterization on this basis difficult. Moreover, the resistance of the suppressor resistor varies significantly with temperature. In an automotive environment, temperature variations are a function of both environmental heating (e.g., engine heat), as well as self-heating (i.e., caused by the flow of spark current through the spark plug).

Of course, there has long been apparatus to test spark plugs, as seen by reference to U.S. Pat. No. 4,032,842 issued to Green et al. entitled “SPARK PLUG TESTER IGNITION SYSTEM.” Green et al. disclose a high voltage pulse power supply for a spark plug test fixture where the spark plug under test is contained in and subjected to increased air pressure. If the plug does not fire under a predetermined air pressure, it is discarded as defective. The fixture of Green et al., however, only provides basic information regarding the spark plug (i.e., did it spark at all?), and not the quantitative information associated with the suppressor resistor that electromagnetic interference (EMI) and ignition system designers and engineers would find desirable.

It is also known to use a conventional multi-meter to measure the suppressor resistance. However, this approach is generally inaccurate, and may be very inaccurate depending on the particular materials and manufacturing process used to make the spark plug. One reason for the inaccuracy is because a conventional multi-meter uses a relatively low current, which does not approximate an actual “in-use” current that flows through a spark plug in actual service. The low current also does not produce a self-heating effect as would be found in actual usage. Moreover, attempts to use discrete voltmeters and power supplies suffer from poor repeatability, inaccuracy, and inefficient use of technician or operator time. Prior attempts using discrete voltmeters, current meters and high voltage power supplies resulted in inconsistent results because of the fast rate in which the suppressor resistance changes upon the initial and subsequent application of test current. Manually reading the meters and recording the measurements is too slow to accurately define the resistance per unit of time. In addition, the resistance values must be calculated using Ohm's Law for each set of measurements to provide the resistance-per-time graphical data. Also, with the use of the controller/data logger (e.g., personal computer) operator-to-operator variation is eliminated.

There is therefore a need for a system for measuring a spark plug suppressor resistance that minimizes or eliminates one or more of the problems as set forth above.

### SUMMARY OF THE INVENTION

One advantage of the present invention is that it provides an accurate measurement of a suppressor resistance of a spark plug under simulated operating conditions. This knowledge of the actual resistance of the suppressor resistor allows ignition system designers to determine that actual energy dissipated by the suppression device, thereby allowing more accurate, overall system design choices (e.g., the needed energy to be delivered by the ignition coil). In addition, this information is beneficial to electromagnetic compliance (EMC) personnel so as to allow implementation of suitable suppression strategies based on the expected EMI noise produced by the spark plug during actual use. Moreover, the improved information provided by a system according to the invention may be profitably employed by spark plug manufacturers in the development and application of their products.

These and other advantages may be obtained by a system for determining a functioning or working resistance of a spark plug. The system includes a controller, a mounting fixture, a power supply, and circuitry configured to detect electrical characteristics of the spark plug when supplied with power. The mounting fixture is configured for receiving the spark plug, and in one embodiment comprises electrical insulating material. The controller, among other things, is configured to produce a control signal that is supplied to the power supply. The power supply is configured to be coupled to the spark plug for sourcing current through the spark plug in response to the generated control signal. This current establishes a self-heating arrangement which provides simulation of actual operating conditions. In addition, the relative magnitude of the current is selected to simulate actual use conditions (i.e., actual spark currents) and limits the test current to protect the spark plug from over-current damage. The circuitry is configured to detect electrical characteristics of the spark plug once supplied with current, and may, in one embodiment, detect the voltage level established across the spark plug, and the current level through the spark plug. The controller is further configured to determine, at predetermined time intervals, a respective resistance value using the detected electrical characteristics (e.g., via Ohm's Law) while the spark plug is being self-heated.

A method of calculating a suppressor resistance of a spark plug, at temperatures below and above the actual test window temperature, is also presented.

### BRIEF DESCRIPTION OF THE DRAWINGS

FIG. 1 is a simplified diagrammatic and block diagram view of a system for measuring a suppressor resistance according to the invention.

FIG. 2 is a perspective view of mounting fixture and non-contact infrared (IR) temperature detector portions of the embodiment shown in FIG. 1.

FIG. 3 is a simplified, cross-section view of the mounting fixture of FIG. 2 taken substantially along lines 3-3.

FIG. 4 is a screen display output of the controller of FIG. 1 illustrating resistance values, and temperature values of the suppressor resistor, as a function of time.

### DETAILED DESCRIPTION OF THE PREFERRED EMBODIMENTS

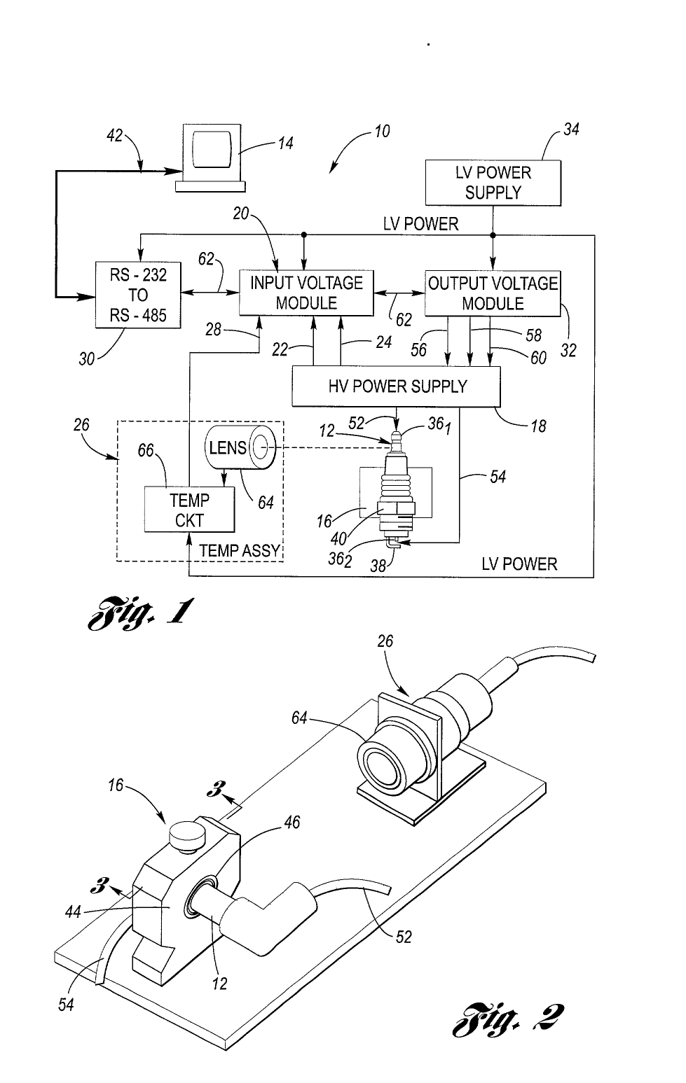

Referring now to the drawings wherein like reference numerals are used to identify identical components in the various views, FIG. 1 is a simplified diagrammatic and block diagram view of a system 10 for measuring a suppressor working resistance of a spark plug 12. As described in the Background, due to a variety of factors, the variation of the value of the suppressor resistance on a per-manufacturer basis, on a per-model even for one manufacturer, and further even as a function of temperature, can no longer be ignored by ignition system and EMI designers and engineers. Conventional approaches for attempting to accurately characterize the suppressor resistance have been unsuccessful. According to the invention, simulated operating conditions established by way of a self-heating arrangement simulate the effects of heating that are present in a real engine application. The actual suppressor resistance is determined at predetermined times, and the output is displayed as a curve of suppressor resistance versus time and temperature versus time, one overlaid on another. The output of the invention, namely the suppressor resistance values, may then be used by ignition system engineers to determine the actual electrical energy needed to be produced, for example, by an ignition coil in a specific application. For example, the required energy to be delivered to the spark plug from an ignition coil is essentially the energy required to be delivered to the spark plug gap plus the energy lost in the spark plug suppressor resistor.

FIG. 1 further shows a controller 14, a mounting fixture 16, a high voltage power supply 18, an input voltage module 20 configured to receive (i) a voltage indicative signal 22 and (ii) a current indicative signal 24, a temperature detector assembly 26 configured to generate a temperature indicative signal 28 provided to module 20, a bus converter module 30, an output voltage module 32, and a low voltage power supply 34.

System 10 is configured, as described above, to measure, under simulated operating conditions, resistance values of the suppressor resistor of a variety of configurations of spark plugs 12. As shown in FIG. 1, spark plug 12 may be of the type having a center electrode, generally designated 36, having an upper, high voltage (HV) connector electrode 36₁, and a lower, center electrode 36₂. Spark plug 12 is further illustrated having a conventional ground strap 38. The location of strap 38 establishes a spark gap between bottom electrode 36₂ and strap 38. The plug 12 further includes a shell 40, conventionally made of steel or other metal alloy, and may further include an integrally formed nut (not shown) to facilitate installation in a spark plug bore in an internal combustion engine.

Controller 14 is configured to produce a variety of control signals, generally identified by reference numeral 42 in FIG. 1. The control signals 42 control the actuation, and relative timing of the operation of the remainder of the components of system 10. Controller 14 may comprise a conventional, general purpose personal computer (PC) executing a windows style operating system (e.g., WINDOWS 95, 98, 2000, etc.). Alternative embodiments, of course, may be implemented on like functioning computers such as an Apple Macintosh, a UNIX type workstation s (e.g., Linux), and the like. In the illustrated embodiment, control signals 42 are output from controller 14 in accordance with a preprogrammed control strategy on an output serial port configured with the widely-known RS-232 serial communications protocol. In the illustrated embodiment, the control signals are not discrete-wire control signals, but are rather digital control words (including data) multiplexed in a serial bit stream. As described in greater detail below, the digital commands are destined for modules 20, 30 and 32, which are in-turn configured to respond to such serial commands. Control 14 may also include conventional input (e.g., keyboard, mouse, etc.), as well as output (screen display, printer, diskette, etc.).

FIG. 2 shows mounting fixture 16 in greater detail and in a perspective view. Mounting fixture 16 is configured for receiving spark plug 12, and includes a body portion 44 having a central through-bore 46. Mounting fixture 16 is formed generally of electrical insulating material, and may comprise, in one embodiment, phenolic material, such as BAKELITE®, commonly available stock material approximately ¾ inch thick. As will be described in greater detail hereinafter, HV power supply 18 is configured, in a constructed embodiment, to produce a maximum of 6,000 volts. Accordingly, mounting fixture 16 has at least an electrical insulating dielectric capacity to withstand 6,000 volts without breakdown. Of course, the type of material, thickness, geometric configuration, and the like, according to the invention, is selected to provide an electrical insulating function, including a suitable safety factor, based on the maximum output of HV power supply 18. As shown in FIG. 2, spark plug 12 is actually disposed in central through-bore 46.

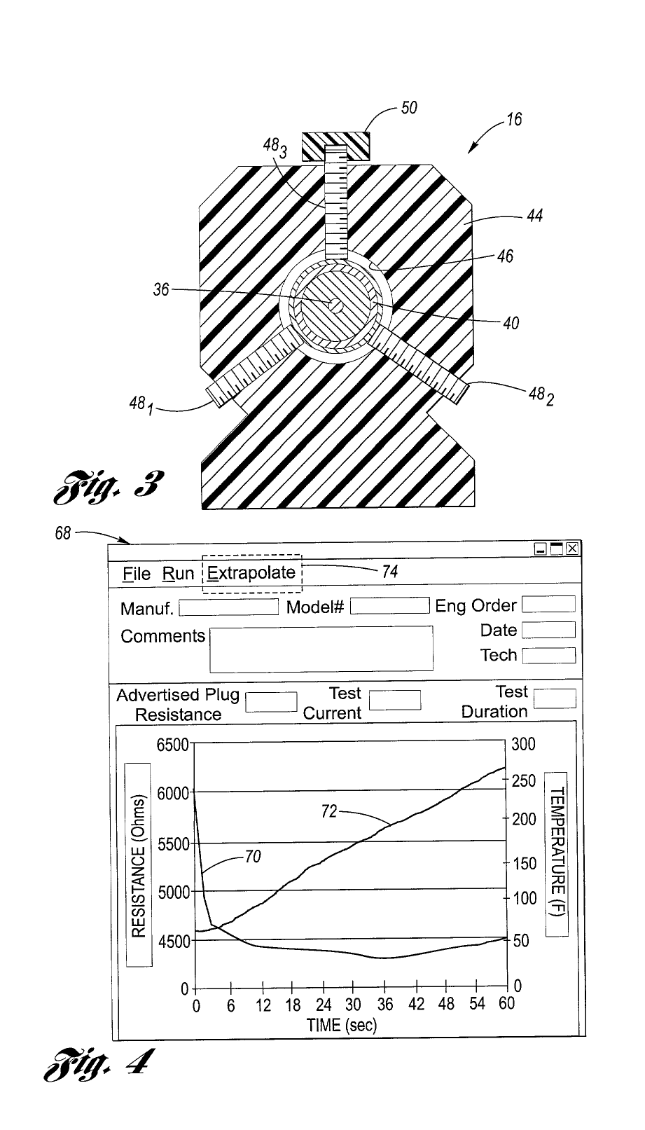

FIG. 3 is a cross-section view of mounting fixture 16 of FIG. 2 taken substantially along lines 3-3. Mounting fixture 16 is shown to include a plurality of retaining contact screws 48₁, 48₂, and 48₃, as illustrated, angularly displaced around the periphery of central through-bore 46, and approximately 120 angular degrees apart. Retaining screw 48₃ includes a thumb wheel, or other hand-operable knob or the like to allow an operator or technician to insert a spark plug 12 under test into the through-bore 46, and to thereafter manually tighten retaining screw 48₃ to hold spark plug 12 in place.

With continued reference to FIG. 1, high voltage (HV) power supply 18 includes power output terminals, which are configured to be coupled to spark plug 12 by way of electrical leads 52 and 54. In a constructed embodiment, electrical lead 52 is adapted for connection to an upper electrode 36₁, (best shown in FIG. 2). Electrical lead 54 is adapted to be connected to a bottom electrode 36₂. In a constructed embodiment, lead 54 may comprise, on an end portion thereof, a conventional alligator-style clip or the like. In alternate embodiments, however, where lower electrode 36₂ is difficult to connect to with such a clip, a variety of other mechanisms may be employed to effect such a connection. For example, the alligator clip on the end of lead 54 may be connected to ground strap 38, and a custom (e.g., perhaps a spring-loaded metal connector) may be used to short ground strap 38 with center electrode 36₂. It should be understood by those of ordinary skill in the art, that a wide variety of alternative connections may be possible, and/or required, depending upon the actual configuration of spark plug 12. However, configuring a suitable connection arrangement requires no more than application of ordinary skill in the art. Accordingly, no further description as to this aspect of system 10 is required.

HV power supply 18 is configured for sourcing electrical current through spark plug 12 in response to various control signals originated with controller 14. Such controls are adapted to establish, in accordance with the present invention, a self-heating arrangement for the spark plug. In a constructed embodiment, HV power supply 18 is responsive to a target voltage-output control signal 56, a target current-output control signal 58, and an enable signal 60. In such a constructed embodiment, the HV power supply 18 comprises a Glassman KL Series 3 kW regulated HV DC power supply, commercially available from Glassman USA, Glassman High Voltage, Inc., High Bridge, N.J., USA. Such supply 18 includes a regulated output voltage of up to 6,000 volts and current of up to 500 mA. The input control signals 56, 58, and 60 are each an analog voltage signal ranging between 0-10 volts.

As to the enable signal 60, a zero voltage disables the power supply output, while a 10 volt signal enables the power supply 18 to produce an output. Signal 60, therefor, implements a safety feature, all as controlled by controller 14. HV power supply 18 can operate in a current control mode, or a voltage control mode. The target voltage-output control signal 56 will control the output of the power supply 18 to a substantially constant output voltage located within its output range (e.g., 0-6,000 volts), depending upon the analog value of the input signal (e.g., 0-10 volts). The HV power supply will source the needed current in order to maintain the commanded output voltage.

In preferred embodiment, however, the HV power supply 18 operates in a current control mode, wherein the output of the power supply is a substantially constant, regulated current based on the analog input voltage level of the target current-output control signal 58 (e.g., between 0-10 volts). Thus, in the current control mode of the preferred embodiment, HV power supply 18 will vary its output voltage in order to maintain the commanded output current up to 500 mA in a constructed embodiment.

In addition, another feature of the HV power supply employed in the preferred embodiment is that it includes circuitry configured to detect electrical characteristics of the spark plug when supplied with power. In particular, HV power supply 18 includes functionality to detect its output voltage (which is applied across plug 12) and generate an actual output voltage indicative signal 22, which is an analog voltage signal ranging between 0-10 volts in the constructed embodiment. Likewise, supply 18 includes further functionality to detect its output current (which flows through plug 12) and generate an actual output current indicative signal 24, which is an analog signal ranging between 0-10 volts in the constructed embodiment.

Bus converter 30 is provided, in a constructed embodiment, to convert the commonly used (on PCs) serial communications protocol RS-232, to another serial protocol RS-485, which is commonly used in industrial environments. The RS-485 serial protocol is essentially a two wire (D+ and D−) physical implementation that can operate over longer distances, and is considered more noise immune than RS-232. It should be understood, however, that bus converter 30 is not required in the present invention, and for that matter, the multiplexing of control signals over a serial communication link from controller 14 need not be used, and may be substituted with a series of discrete, analog control signals to accomplish the same result. Bus converter 30, in a constructed embodiment, may comprise commercially available components, such as Model CB-7520, an Isolated RS-232 to RS-485 Converter, available from Measurement Computing Corp., Middleboro, Mass., USA (formerly known as ComputerBoards). Bus converter 30 output connected to a serial communications link 62.

Input voltage module 20 is configured to receive and sample one or more discrete analog voltages on a plurality of inputs thereof, and convert each sample to a corresponding digital value (i.e., functions as a multichannel analog-to-digital converter). In a constructed embodiment, input voltage module 20 may comprise commerically available components, such as a Model CB-7017, Eight Channel Voltage Input Module, commercially available from Measurement Computing Corp., Middleboro, Mass., USA (formerly known as ComputerBoards). In a constructed embodiment, commands to take and digitize samples are received by module over link 62. The digitized input voltages are 16-bit words, and are then sent back to controller 14 over serial communications link 62 for further processing.

Likewise, output voltage module 32 is configured to output one or more analog voltage signals on a plurality of outputs thereof based on a received digital word on a serial communications link 62 input thereto. In effect, output voltage module 32 is a linked digital-to-analog converter having multiple outputs. In a constructed embodiment, output voltage module 32 comprises a Model CB-7024 Four Channel Analog Voltage Output Module, commercially available from Measurement Computing Corp., Middleboro, Mass., USA (formerly known as ComputerBoards).

Temperature detector assembly 26 has an output that is coupled to controller 14 by way of input voltage module 20. Assembly 26 is disposed in sensing proximity to mounting fixture 16 for detecting a temperature value of spark plug 12. This is best shown in FIG. 2. In a constructed embodiment, temperature detector assembly 26 includes a non-contact, infrared (IR) thermometer/transmitter having an IR lens 64, and a corresponding conditioning/transmission circuit 66. Lens 64 may be aimed at the ceramic barrel portion of spark plug 12 (e.g., as shown, approximately 6 inches from the barrel of plug 12), in order to sense the temperature of the spark plug. Circuit 66 generates a temperature indicative signal 28 having an analog voltage ranging between 0-10 volts. Signal 28 has a magnitude that corresponds to the detected temperature. Temperature detector assembly 26 may comprise commercially available components, such as a infrared pyrometer module, Omega OS 550 series, available from Omega Engineering, Inc., Stamford, Conn., USA.

Low voltage (LV) power supply 34 is configured to produce relative low voltage (e.g., 24 Vdc, in one embodiment) to provide powering for modules 20, 30, 32, and the temperature detector assembly 26. Power supply 34 may comprise conventional components known to those of ordinary skill in the art.

FIG. 4 is a screen display output 68 produced by controller 14 according to the invention. Controller 14 may be configured, through software, to achieve the functions described herein. For example, in a constructed embodiment, a VISUAL BASIC programming language, having pre-programmed functional modules available, was used to implement the user interface, control of the testing and measuring equipment/process, and display of the output. Of course, other approaches, including the use of other programming languages, may be made and still remain within the spirit and scope of the present invention.

Initially, the controller 14 via the software is configured to produce a graphical user interface (GUI) for receiving a plurality of inputs needed or desired to run the test of spark plug 12. One input that the interface is configured to receive, for example from an operator, corresponds to a preselected, desired current to be sourced by HV supply 18 through the spark plug 12. This input may be made by the operator as shown in FIG. 4 by typing the desired value in the input box labeled “Test Current”. As shown in the FIG. 4, the illustrated value is 100 mA. It should be understood that the test current may assume a variety of values. Typically, the preselected current is greater than is preferably greater than about 10 mA and less than about 500 mA, and more typically between about 50 mA and 200 mA.

Another input that the interface is configured to receive is a preselected duration. The duration is the time in which the preselected current is to be applied to the spark plug, and, as shown in FIG. 4, may be typed in by an operator into an input box labeled “Test Duration.” As shown in FIG. 4, the exemplary duration is 60 seconds, although it should be understood that test duration is configurable and variable for example from 0.5 seconds to 120 seconds.

Yet another input that the interface is configured to receive is the nominal plug resistance. This value may be typed by an operator into an input box labeled “Advertised Plug Resistance” in FIG. 4. In accordance with the invention, the numeric value entered in this box implements another safety feature, insofar as the entered value places a cap on the maximum output voltage of power supply 18. That is, the lower the value, the lower the maximum voltage will be needed to obtain the commanded current. Thus, the output voltage of supply 18 is capped so that no unnecessary voltage is applied to plug 12.

In addition, the interface is configured to receive various other items of information relating to the test, such as the name of the plug manufacturer (in the box labeled “Manufacturer”), the identity of the spark plug (in the box labeled “Model #”), an engineering order number, the date the test was run, the technician or operator running the test, and a general space for comments.

Once the above-information (only test current and duration required) is received by controller 14 via the interface, the software is poised to run the test, but will defer until the operator expressly initiates the test, for example, by way of the “run” command from the pull down menu (as shown in FIG. 4).

When execution of the test commences, controller 14, by way of the serial links described above, sends out a variety of control signals 42 addressed for output voltage module 32. The module 32, in turn, produces control signals 56, 58 and 60 having suitable levels to condition and enable power supply 18 to begin applying power to plug 12 (i.e., begin self-heating). In timed relation with these commands, controller 14, by way of input voltage module 20, sends control signals thereto to receive and sample the temperature indicative signal 28, along with the voltage indicative signal 22 and current indicative signal 24. The digitized equivalents of the temperature, and voltage/current is sent by module 20 to controller 14. Controller 14 then calculates, for example by way of Ohm's law, the resistance using the digitized values of the voltage indicative and current indicative signals 22, and 24.

Thereafter, at predetermined intervals throughout the duration of the test, controller 14 continually controls the supply to maintain the desired current, and continually sends out commands to sample temperature/voltage/current. From these data streams, controller 14 determines a plurality of suppressor resistance values, as well as according a corresponding plurality of temperature values.

As further shown in FIG. 4, controller 14 is further configured to display the measured resistance of the suppressor resistor of plug 12 at predetermined intervals, as a function of time, as shown in trace 70. In addition, controller 14 is also configured to displays the measured temperature values at the same predetermined intervals, as a function of time. The temperature trace 72 is overlaid on the display with the trace 70 of the resistance values. Through the foregoing, a highly accurate characterization of the resistance of the suppressor resistor of spark plug 12, as a function of temperature and of time, is obtained. Controller 14 preferably makes use of conventional, widely known curve-fitting approaches to produce smooth, continuous traces 70, and 72. Note that the sampling interval for temperature and voltage/current may by much shorter than the interval shown in the display. For example, many samples of each graphed parameter may be made each second, while the output display is shown in 6 second increments.

In another aspect of the invention, controller 14 is further configured to provide an extrapolate function, invoked by an operator by selecting the pull down menu “Extrapolate” shown in box 74 in FIG. 4. This function allows, for example, an ignition system designer to ascertain the resistance value of the suppressor resistance at a temperature outside of the temperature range of the test. For example, the extrapolate functionality will provide the resistance value at −20° Fahrenheit, a temperature outside of the range of the test. Importantly, the software examines a preselected range of resistance value/temperature value data point pairs, for example taken between the times 10-20 seconds, and determines a slope. From the foregoing determined slope, a resistance value can be determined at a particular temperature. Through the foregoing, an extrapolation that is accurate in nature may be obtained. It bears emphasizing that the resistance value readings taken at the commencement of the test, until about the 3-4 second mark, reflect the unique characteristic of the suppressor resistor materials (e.g., glass/carbon/metal oxides, etc.), and which do not correspond to a conventional resistor, such as a carbon resistor. The suppressor resistor not only exhibits varying electrical characteristics based on temperature, but also in terms of the voltage and/or current level applied thereto. For example, the initial reading shown for trace 70 of FIG. 4, namely 6063 ohms, may correspond to the reading that one might obtain from a conventional multi-meter that applies only a low voltage (e.g., 3 volts), as described in the Background. As can be seen, at typical operating temperatures and power levels, the plug suppressor resistance of the plug under test as shown in FIG. 4 is somewhere in the range of 4300-4500 ohms, which is significantly less than the nominal plug resistance of 6 k ohms.

The self-heating arrangement of the present invention, coupled with the increased voltage/current levels (i.e., as compared to a conventional multi-meter), provides improved accuracy in the measurement of resistance values of the suppressor resistor in a spark plug compared to conventional approaches. This improved information allows an ignition system designer/engineer and/or an EMI compliance designer/engineer to more effectively design ignition systems, and control EMI, respectively. In addition, the system of the present invention may be used to detect defective spark plugs (i.e., by the measured resistance levels, that would otherwise go undetected using a low voltage (e.g., multi-meter) approach.

In addition, a computer-controlled system 10 allows for calibration of the system (e.g., inserting a known resistance in place of the spark plug) in order to meet quality control and other quality requirements (e.g., QS-9000).

1. A system for determining a working resistance of a spark plug comprising:
a controller configured to produce a control signal;
a mounting fixture for receiving the spark plug;
a power supply configured to be coupled to the spark plug in the mounting fixture for sourcing current through the spark plug in response to said control signal to thereby establish a self-heating arrangement; and
circuitry configured to detect electrical characteristics of the spark plug when supplied with current;
wherein said controller is configured to determine at predetermined intervals a respective resistance value at predetermined intervals in response to said detected electrical characteristics while the spark plug is being self-heated.

2. The system of claim 1 wherein said mounting fixture comprises electrical insulating material and includes a region configured to receive the spark plug, said system further including a temperature detector coupled to said controller and located in sensing proximity to said region for detecting a temperature value of the spark plug.

3. The system of claim 2 wherein said controller is further configured to input a corresponding temperature value from said temperature detector; and associate said resistance values and said temperature values.

4. The system of claim 3 wherein said controller is further configured to generate a display illustrating the resistance values and said temperature values at said predetermined intervals.

5. The system of claim 1 wherein said controller is configured to produce an interface for receiving inputs corresponding to a preselected current to be sourced through the spark plug by said power supply and a preselected duration in which said preselected current is to be applied.

6. The system of claim 5 wherein said preselected current is between about 10 mA and 500 mA.

7. The system of claim 5 wherein said preselected current is between about 50 mA and 200 mA.

8. The system of claim 5 wherein said preselected duration is less than about 60 seconds.

9. The system of claim 1 wherein said circuitry comprises:
a voltage detector configured to detect a voltage across the spark plug; and
a current detector configured to detect a current through the spark plug.

10. The system of claim 1 wherein said controller comprises a general purpose digital computer.

11. A system for determining a resistance of a spark plug comprising:
a controller configured to produce a power control signal;
a mounting fixture formed of electrical insulating material having a region for receiving the spark plug;
power supply configured to be coupled to the spark plug in the mounting fixture for sourcing current through the spark plug in response to said power control signal to thereby establish a self-heating arrangement;
a temperature detector coupled to said controller and located in sensing proximity to said region for detecting a temperature value of the spark plug;
circuitry configured to detect electrical characteristics of the spark plug when supplied with power;
wherein said controller is configured, at predetermined intervals, (i) to determine a respective resistance value of the spark plug in response to said detected electrical characteristics; (ii) to input a corresponding temperature value from said temperature detector; and (iii) associate said resistance values and said temperature values.

12. The system of claim 10 wherein said controller is further configured to generate a display illustrating the resistance values and said temperature values at said predetermined intervals.

13. The system of claim 11 wherein said controller is configured to produce an interface for receiving inputs corresponding to a preselected current to be sourced through the spark plug by said power supply and a preselected duration in which said preselected current is to be applied.

14. The system of claim 12 wherein said circuitry comprises:
a voltage detector configured to detect a voltage across the spark plug; and
a current detector configured to detect a current through the spark plug.

15. The system of claim 13 wherein said preselected current is between about 10 mA and 500 mA, and said preselected duration is less than about 0.5 to 300 seconds.

16. A method of measuring a resistance of a spark plug comprising the steps of passing an electrical current through the spark plug to effect a self-heating thereof, and measuring a resistance value of the spark plug.

17. The method of claim 15 wherein said passing step is performed over a preselected duration, and said resistance measuring step is performed at predetermined intervals over said duration.

18. The method of claim 16 further comprising the step of detecting a respective temperature of the spark plug at said predetermined intervals.

19. The method of claim 17 further comprising the step of displaying the resistance values and the temperature values at the predetermined intervals.
